(19) United States
(12) Patent Application Publication
(10) Pub. No.: US 2019/0357555 A1
(43) Pub. Date: Nov. 28, 2019

(54) BLUEBERRY FRESH-KEEPING AGENT, PREPARATION METHOD AND APPLICATIONS THEREOF

(71) Applicant: ZHEJIANG ACADEMY OF AGRICULTURAL SCIENCES, HANGZHOU (CN)

(72) Inventors: HAIYAN GAO, HANGZHOU (CN); WEIJIE WU, HANGZHOU (CN); HANGJUN CHEN, HANGZHOU (CN); XIANGJUN FANG, HANGZHOU (CN); HONGLEI MU, HANGZHOU (CN); QIANG HAN, HANGZHOU (CN); YANCHAO HAN, HANGZHOU (CN); RUILING LIU, HANGZHOU (CN); YONGJUN ZHOU, HANGZHOU (CN)

(21) Appl. No.: 16/533,700

(22) Filed: Aug. 6, 2019

Related U.S. Application Data
(63) Continuation of application No. PCT/CN2019/078610, filed on Mar. 19, 2019.

(30) Foreign Application Priority Data
May 24, 2018 (CN) 201810504765.7

(51) Int. Cl. A23B 7/154; A23B 7/10

(52) U.S. Cl. CPC A23B 7/154; A23B 7/10

(57) ABSTRACT

The present disclosure provides a blueberry fresh-keeping agent, preparation method and applications thereof, the fresh-keeping agent consisting of 0.03%-0.5% of a Galla chinensis extract, 0.5%-1.0% of ascorbic acid and 1.0%-2.0% of chitosan, and pH is 2.0-6.0. The fresh-keeping agent provided by the present disclosure may significantly inhibit blueberry Botrytis cinerea, effectively alleviate post-harvest blueberry membrane lipid peroxidation, maintain blueberry cell membrane completeness, and extend storage time of blueberries from 20 days in conventional cooling to 50 days, blueberry decay rate is reduced within 10%, and weight loss rate is controlled within 5%, achieving relatively long-term, high-quality fresh-keeping storage of blueberries. The blueberry fresh-keeping agent of the present disclosure is safe to use, and blueberries treated have no toxic and harmful substances, and have the characteristics of high efficiency, safety and environment-friendly.

### CROSS-REFERENCE TO RELATED APPLICATIONS

This application is a continuation of International Application No. PCT/CN2019/078610, filed on Mar. 19, 2019, which claims priority to Chinese Patent Application No. 201810504765.7, filed on May 24, 2018. The disclosures of the aforementioned applications are hereby incorporated by reference in their entireties.

### TECHNICAL FIELD

The present disclosure relates to the technical field of fresh fruit green antisepsis and fresh-keeping, and particularly relates to a blueberry green safe fresh-keeping agent, preparation method and applications thereof.

### BACKGROUND

Blueberry fruit has unique flavor and is rich in anthocyanin, flavonoid, vitamin C, folic acid, ellagic acid and other physiologically active substances, which have health efficacies of anti-aging, blood pressure lowering, anti-oxidation and anti-cancer, and is considered as one of the top five healthy fruits, and is favored by consumers, thus there is a very broad market prospect for it. However, the harvest period of blueberry is high-temperature and rainy, fruit has a high amount of water, and skin is thin, and it is easy to decay after harvest, and loss rate thereof is as high as 20%-40%. In addition, blueberry is susceptible to be invaded by pathogenic fungi during storage, causing drastic changes in its structure, nutrition, and physiological and biochemical reactions, and fruit quality is reduced and shelf-life is shortened, which severely restricts the development of blueberry industry, and brings great difficulties in storage and circulation of blueberry. Therefore, it is important to do a good job in disease-resistance and fresh-keeping of post-harvest blueberry to reduce the loss thereof

In order to alleviate decay and deterioration of post-harvest blueberry fruit, fresh-keeping techniques commonly used at present mainly include pre-harvest antibacterial agent spraying, post-harvest chlorine dioxide aqueous solution soaking, high-voltage electrostatic field treating, CO₂ gas-modulated and irradiated fresh-keeping. The antibacterial agent spraying and chlorine dioxide aqueous solution soaking may effectively control saccharomycetes and mold attached to blueberry, however, blueberry has no obvious exocarp, post-harvest fruit is directly eaten, and chemical antibacterial agent is difficult to remove, resulting in potential safety hazard; the high-voltage electrostatic field treating fresh-keeping technology has broad market prospect due to its low energy consumption, health, and easy to operate, however, the treating technology needs a high voltage that is dangerous, and requires high environmental humidity, and is poor in repeatability of treating results; the CO₂ gas-modulated and irradiated fresh-keeping technology has the disadvantages of high cost, high energy consumption and high cost. Therefore, developing a fresh-keeping agent with low price, remarkable effect, safety and environment-friendly is a hot spot of current researches and has important economic significance.

Botrytis cinerea is one of the most important pathogens in post-harvest blueberry, and the carrier rate of Botrytis cinerea on blueberry is as high as 81.85%. Especially under the condition of high humidity after rainy days, gray mold pathogens are easy to breed and become prevalent, causing blueberry gray mold, resulting in decay of post-harvest blueberry. Therefore, the purpose of blueberry disease-resistance and fresh-keeping may be achieved by inhibiting the reproduction of blueberry Botrytis cinerea. Sulfur dioxide fumigation method has been proven to effectively kill decayed fungi such as Botrytis cinerea and Penicillium, and reduce the incidence of gray mold during storage and transportation of post-harvest blueberry. However, the residual sulfur dioxide has certain toxicity, excessive intake is harmful to human body, and there are strict limits on the amount of SO₂ residues in food at home and abroad. Plant-derived antibacterial substances have become good substitutes for chemical fresh-keeping agents because of safety, low toxicity and high efficiency thereof, which have become a hot spot and development trend of current researches.

Galla chinensis, also known as clam, white insect storehouse, woody monkshood, is a general designation of insect gall formed by Eriosomatidae insects of Schlechtandalia chinensis bell or egg aphid parasitizing at different parts of their host Anacardiaceae plant (such as Rhus chinensis, Rhus. potaniinii, Rhus. punjabensis), and has antibacterial, antioxidative and convergence effects. Galla chinensis, besides used as a traditional Chinese medicine, is used as a basic material for various chemical products which are widely used in medicine, metallurgy, food, aerospace and other fields. Chemical components of Galla chinensis mainly include tannin, gallic acid, gallnut oil, flavonoid, organic acid, resin, protein, fat, starch, wax, etc., where Chinese Gallotannins (CGTs) are the main functional component and the largest component of Galla chinensis, the amount may reach to 50%-70%. Chinese Gallotannins, also known as tannic acid, are a mixture of various polygalloyl glucose esters, and have a variety of isomers. Chinese Gallotannins may exert antibacterial and antiviral effects by precipitating proteins, particularly enzymes. Tian et al. found that Chinese Gallotannins may effectively inhibit pathogenic bacteria such as Staphylococcus aureus, Escherichia coli and Salmonella typhimurium, but it has no inhibitory effect on fungi such as Saccharomyces cerevisiae, Rhizopus oryzae or Trichoderma species (Tian, F., et al. Antioxidant and antimicrobial activities of consecutive extracts from Galla chinensis: The polarity affects the bioactivities. Food Chemistry, 2009 (1). 113(1): 173-179; Tian, F., et al. Identification and structure-activity relationship of gallotannins separated from Galla chinensis. LWT-Food Science and Technology, 2009 (2). 42(7): 1289-1295). Kai JINAG found that Chinese Gallotannins have certain antibacterial effect on bacteria (such as Listeria monocytogenes) and fungi (such as Penicillium expansum) (Kai JINAG, The Extraction and Purification of Chinese Gallotannins and Its Antibiosis and Antimutagenicity Effect, Master's thesis of Shaanxi Normal University, 2011). Gallic acid (also known as Gallate) is another major active component of Galla chinensis. Clinical studies have shown that it also has antibacterial and antiviral effects, and is widely used in medicine, food and agriculture.

At present, there is no report about studying inhibition of Galla chinensis against blueberry pathogenic bacteria (Botrytis cinerea). The present disclosure aims to develop a green fresh-keeping agent with a Galla chinensis extract as a main component by studying the inhibitory effect of the Galla chinensis extract on Botrytis cinerea, which is used for controlling diseases, greatly prolonging shelf life of post-harvest blueberry and improving quality of the blueberry.

### SUMMARY

With respect to the deficiency in control of post-harvest blueberry diseases in the prior art, one of the objects of the present disclosure is to provide a blueberry fresh-keeping agent. The fresh-keeping agent is consisted of a Galla chinensis extract, ascorbic acid and chitosan, which may effectively inhibit the main pathogenic bacteria (Botrytis cinerea) causing post-harvest blueberry decay, thereby achieving the effect of blueberry disease prevention and fresh-keeping.

In some preferred embodiments, the components of the blueberry fresh-keeping agent comprise, by weight percent, 0.03%-0.5% of the Galla chinensis extract, 0.5%-1.0% of the ascorbic acid, and 1.0%-2.0% of the chitosan.

In some preferred embodiments, the blueberry fresh-keeping agent has a pH of 2.0 to 6.0.

A method for preparing the blueberry fresh-keeping agent is carried out according to the following steps: (1) preparing the Galla chinensis extract: removing internal eggs of high-quality dried Galla chinensis, then pulverizing using a high-speed powder machine, and ultrasonically extracting with 75% ethanol at room temperature, centrifuging and collecting a supernatant, and rotationally evaporating the supernatant to dryness, a crude extract is obtained; redissolving the crude extract with water, extracting with ethyl acetate and collecting an ethyl acetate layer, evaporating the ethyl acetate layer to dryness, the Galla chinensis extract is obtained; (2) separately adding the Galla chinensis extract, the ascorbic acid and the chitosan by weight percentage to distilled water for dissolving; (3) after a mixed solution is thoroughly stirred and mixed, pH is adjusted to 2.0-6.0, the blueberry fresh-keeping agent is obtained.

In some preferred embodiments, in the method for preparing the above blueberry fresh-keeping agent, a ratio of solid to liquid during ethanol extraction of the Galla chinensis is 1:10-1:20 (W/V), and an ultrasonic treatment time is 0.5-2 hours, a vacuum rotational evaporation temperature is no more than 60° C.

In some preferred embodiments, when preparation of the blueberry fresh-keeping agent, Tween 80 of 0.5% to 2% is added for solubilization during the dissolving.

In another aspect, the present disclosure provides a method for treating blueberries with the blueberry fresh-keeping agent, wherein by using the treatment method, a decay rate of blueberry fruit may be effectively reduced to less than 10%, a storage time is prolonged to more than 50 days, a weight loss rate is controlled within 5%, which significantly improves blueberry quality.

In some preferred embodiments, the method for treating blueberries with the blueberry fresh-keeping agent includes the following steps: (1) rinsing blueberries freshly picked with water, draining for use; (2) soaking the rinsed blueberries in the blueberry fresh-keeping agent, taking out, drying and placing in a plastic box with air holes; (3) pre-cooling the blueberries treated with the blueberry fresh-keeping agent in a pre-cooling storage and storing at a low temperature.

In some preferred modes, a time for soaking with the blueberry fresh-keeping agent is 1-2 min, a temperature of the pre-cooling storage is 1° C.-5° C., a pre-cooling time is 2-4 hours, and the temperature of the storing is 1° C.-5° C.

In another aspect, the present disclosure provides a use of a fresh-keeping agent in the preparation of an agent for inhibiting Botrytis cinerea on blueberries, wherein the fresh-keeping agent is consisted of 0.03%-0.5% of a Galla chinensis extract, 0.5%-1.0% of ascorbic acid and 1.0%-2.0% of chitosan, and the fresh-keeping agent has a pH of 2.0-6.0.

Compared with the prior art, the beneficial effects of the present disclosure are:

(1) The present disclosure is directed to the problems that post-harvest blueberries are easy to decay, change color, and juiciness during storage. By researching on the Galla chinensis extract, and the inhibiting effect of a combination of the Galla chinensis extract, ascorbic acid and chitosan on Botrytis cinerea, which is the main pathogen that causing post-harvest blueberry decay, a blueberry green fresh-keeping agent with the Galla chinensis extract as a main component is developed. The fresh-keeping agent of the present disclosure has a pH of 2.0-6.0, and should be prepared when it will be used so as to achieve high-efficiency antibacterial effect. The fresh-keeping agent of the present disclosure has the characteristics of high efficiency, safety and environment-friendly, and a main raw material is derived from traditional Chinese medicine, and is safe to use, and the treated blueberries have no toxic and harmful sub stances.

(2) The present disclosure provides a blueberry fresh-keeping method, blueberry fresh-keeping preservation is achieved by soaking blueberries in the blueberry fresh-keeping agent for a short time, pre-cooling in a pre-cooling storage and cooling. The fresh-keeping method is simply operated and short in treatment time, may effectively alleviate post-harvest blueberry membrane lipid peroxidation, maintain the completeness of the blueberry cell membrane, resulting in that blueberry storage time is prolonged from 20 days to 50 days in conventional refrigeration, and blueberry decay rate is reduced to less than 10%, weight loss rate is controlled within 5%, thus a relatively long-term, high-quality blueberry fresh-keeping storage can be achieved.

(3) A fresh-keeping agent developed by the present disclosure has the Galla chinensis extract as a main component, and it is shown through the research of the present disclosure that gallic acid, which is one of the main components in Galla chinensis, does not have antibacterial effect in blueberry antisepsis and fresh-keeping, and the effect may be a result of combination of Chinese Gallotannins or penta galloy glucose (β-PGG) and several other components and factors. Moreover, the combination of ascorbic acid and chitosan enhances the antibacterial effect of the Galla chinensis extract, such that the fresh-keeping agent has significant blueberry antiseptic and fresh-keeping effects.

### BRIEF DESCRIPTION OF THE DRAWINGS

FIG. 1 is a diagram of inhibition rate of the Galla chinensis extract against Botrytis cinerea.

FIG. 2 is a diagram of the effect of pH on antibacterial stability of the Galla chinensis extract.

FIG. 3 is a diagram of the effect of temperature on antibacterial stability of the Galla chinensis extract.

FIG. 4 is a diagram of the effect of irradiation time on antibacterial stability of the Galla chinensis extract.

FIG. 5 is a diagram of the effect of the fresh-keeping agent on decay rate and weight loss rate of blueberry fruit, where FIG. (A) shows the decay rate of blueberry fruit, and FIG. (B) shows the weight loss rate of blueberry fruit.

FIG. 6 is a diagram of the effect of the fresh-keeping agent on blueberry fruit membrane permeability and membrane lipid peroxidation, wherein FIG. (A) shows the effect of the fresh-keeping agent on membrane permeability, and FIG. (B) shows the effect of the fresh-keeping agent on membrane lipid peroxidation.

FIG. 7 is a diagram of the effect of the fresh-keeping agent treatment on the activity of enzymes related to blueberry disease resistance, wherein FIG. (A) shows the effect of the fresh-keeping agent treatment on the activity of phenylalanine ammonia-lyase, and FIG. (B) shows the effect of the fresh-keeping agent treatment on the activity of polyphenol oxidase.

### DESCRIPTION OF EMBODIMENTS

The contents of the present disclosure will be more specifically described below with reference to embodiments. It is to be understood that the present disclosure is not limited to the embodiments described below, and that any form of modifications and/or changes made to the present disclosure are intended to fall within the protection scope of the present disclosure.

In the present disclosure, unless otherwise specified, all parts and percentages are units of weight, and all devices and raw materials are commercially available or commonly used in the industry. Unless otherwise specified, the methods employed in examples are general techniques in the art.

Galla chinensis used in examples was picked from Zhangjiajie, Hunan; blueberry species was “Legacy”, and they were picked from the “Senzhilan” planting base in Anji County, Hangzhou City, Zhejiang Province.

### Example 1 Inhibition of the Galla chinensis Extract, Chitosan and Ascorbic Acid Against Botrytis cinerea

1. Preparation of the Galla chinensis Extract

Removing internal eggs of high-quality dried Galla chinensis and then pulverizing using a high-speed powder machine, and ultrasonically extracting with 75% (V/V) ethanol, solid-liquid ratio of 1:15 (W/V) at room temperature (power 300 W) for 1 h, centrifuging for 10 min and collecting a supernatant, and rotationally evaporating the supernatant to dryness at 50° C., a crude extract is obtained; redissolving the crude extract with water, extracting with ethyl acetate and collecting an ethyl acetate layer, and evaporating the ethyl acetate layer to dryness, the Galla chinensis extract is obtained.

2. A Inhibition Test of the Galla chinensis Extract, Chitosan and Ascorbic Acid Against Botrytis cinerea

Test species and reagents: Botrytis cinerea was isolated from the picked blueberries in the laboratory, and chitosan and ascorbic acid were purchased commercially.

Medium and culture conditions: a PDA medium was used, and cultured at 28° C. for 6 days.

Antibacterial effect test: after Botrytis cinerea was activated with the PDA medium, lawn of Botrytis cinerea was picked up and suspended with sterile water to obtain a bacterial suspension. Scraps of filter paper with a diameter of 1 cm were made from a highly absorbent filter paper by using a puncher, and the scraps of filter paper were subjected to dry heat sterilization and soaked in the Galla chinensis extract, a chitosan solution, and an ascorbic acid solution, respectively, and dried for use after 4 hours soaking. The solid PDA medium was melted, poured into a culture dish, cooled and solidified, then 0.1 mL of the bacterial suspension was added and uniformly coated, and then the scraps of filter paper soaked with the above solutions were attached to the bacteria-containing culture dish, and a scrap of filter paper impregnated with sterile water was used as a control. The culture dish treated above was cultured at 28° C. for 6 days, and the diameters of inhibition zones were measured.

TABLE 1
Antibacterial effect of the Galla chinensis extract,
chitosan, ascorbic acid and gallic acid

| reagents | inhibition zone diameter/mm |
|---|---|
| Galla chinensis extract | 18.30 |
| chitosan | 0.00 |
| ascorbic acid | 0.00 |
| gallic acid | 0.00 |

The above results show that the Galla chinensis extract has a strong inhibitory effect on Botrytis cinerea, while chitosan and ascorbic acid have no inhibitory effect on Botrytis cinerea.

In order to determine active substances that have antibacterial effects in the Galla chinensis extract, antibacterial effect of gallic acid (commercially purchased), one of the main components in Galla chinensis, on Botrytis cinerea was studied. The result showed that gallic acid had no inhibitory effect on Botrytis cinerea, indicating that the substance that has antibacterial effect in the Galla chinensis extract was not gallic acid.

### Example 2 Antibacterial Effect of the Galla chinensis Extract in Different Concentrations

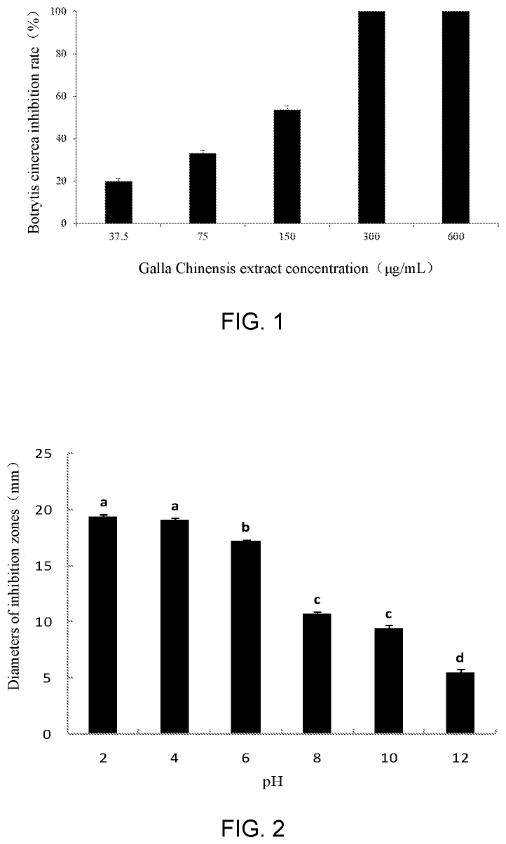

The Galla chinensis extract was dissolved in 10% of Tween80 to fully emulsify, a Galla chinensis suspension was obtained. When the melted PDA medium was cooled to about 50° C., to which a certain volume of the Galla chinensis suspension was added, and the mixture was subjected to fully shaking and mixing, then poured the mixture onto plates, such that final concentrations of the Galla chinensis extract in the plates were 37.5 μL/mL, 75 μL/mL, 150 μL/mL, 300 μL/mL, and 600 μL/mL. A plate to which no Galla chinensis extract was added in the medium was used as a control. After culturing for 7 days, a bacteria block with a diameter of 6 mm was taken from a pathogenic bacterial plate (which can be obtained by: a solid PDA medium was melted, poured into a culture dish, cooled and solidified, then 0.1 mL of the bacterial suspension was added and uniformly coated on the medium, then the pathogenic bacterial plate was cultured) and placed on the center of each PDA plate (90 mm in diameter) using a sterile puncher, which were cultured in a biochemical incubator at 28° C. for 6 days to observe antibacterial effect. The diameters of bacterial colonies were measured using a cross method and inhibition rate was calculated. There were three plates for each concentration gradient and the test was repeated for 3 times. Inhibition rate (%)=(control colony diameter-treated colony diameter)/(control colony diameter−6 mm)×100. The minimum antibacterial agent concentration with inhibition rate of 100% was its minimum inhibitory concentration (MIC). As can be seen from FIG. 1, the MIC of the Galla chinensis extract against Botrytis cinerea was 300 μL/mL.

### Example 3 Effect of pH on Antibacterial Effect of the Galla chinensis Extract

pH values of the Galla chinensis extract were adjusted to 2, 4, 6, 8, 10, and 12 using acetic acid, and the inhibitory effects of Galla chinensis extracts with different pH values on Botrytis cinerea were compared, and the experimental procedure was described in Example 1.

It could be seen from FIG. 2 that pH had a great influence on the antibacterial activity of the Galla chinensis extract. With the increase of pH value, diameters of inhibition zones for the Galla chinensis extract gradually decreased. The Galla chinensis extract had a strong antibacterial activity under acidic condition, while in alkaline condition, the Galla chinensis extract substantially loss its antibacterial activity. That was because part carboxyl groups and phenolic hydroxyl groups of some compounds in the Galla chinensis extract will have different degrees of dissociation with the increase of pH value in an external environment, which will leading to destroy of the original structure of the compounds. Therefore, the acidic condition is more conducive to the antibacterial effect of the Galla chinensis extract.

It was reported that gallnut tannin was a polyphenolic compound that was easily hydrolyzed, which may be hydrolyzed under acidic and basic conditions to produce intermediates such as gallic acid and penta galloy glucose (β-PGG). It is possible that the mutual transformation between these intermediates causes the contents of gallnut tannin, gallic acid and β-PGG showing corresponding changes under different pH conditions.

In combination with the experimental result of Example 1, we speculated that the substance that has antibacterial effect in the Galla chinensis extract was not gallic acid, may be gallnut tannin, or it is a result of combination of multiple components and multiple factors, what component exactly playing an antibacterial role and the antibacterial mechanism thereof needs to be further studied.

### Example 4 Effect of Temperature on Antibacterial Effect of a Galla chinensis Extract

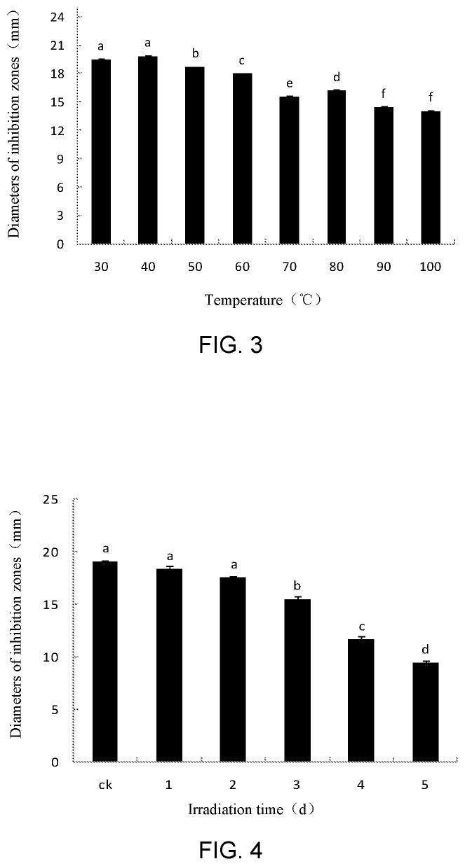

Antibacterial activity of the Galla chinensis extract at different temperatures was measured by using the diameters of inhibition zones of Botrytis cinerea as detection objects. It can be seen from FIG. 3 that the overall trend of antibacterial activity of the Galla Chinensis extract decreased as the increase of temperature, but only decreased by 26.32%, the Galla chinensis extract partially degraded as the increase of temperature, but due to a short treatment time, the overall downward trend was not obvious. High-temperature treatment in a short time has a certain effect on activity of the Galla chinensis extract, and high-temperature treatment in a long time would lead to the degradation, structural change of active substances in the Galla chinensis extract, thereby causing the decrease of antibacterial activity. In order to ensure antibacterial activity of the Galla chinensis extract, an extraction temperature or use temperature should be lower than 60° C.

### Example 5 Effect of Irradiation on Antibacterial Effect of the Galla chinensis Extract

The effect of irradiation time on antibacterial effect of the Galla chinensis extract was shown in FIG. 4. As the increase of irradiation time, the diameters of inhibition zones showed a decrease trend, especially after 3 days of continuous irradiation, the diameters of inhibition zones were decreased more obviously. This was due to the Galla chinensis extract includes tannins, gallic acid and the like, and there was a decrease in absorbance of these substances under uninterrupted irradiation, resulting in a decrease in stability, thus antibacterial effect was affected. Thus, the Galla chinensis extract should be prepared when it will be used, so as to avoid long-term exposure.

### Example 6 Inhibition of a Fresh-Keeping Agent Containing the Galla chinensis Extract as a Main Component Against Botrytis cinerea

1. Preparation of the Fresh-Keeping Agent

The Galla chinensis extract, ascorbic acid, and chitosan, by weight percentage, were dissolved in distilled water, solubilized with 2% of Tween 80, stirred and mixed, and pH was adjusted to 4.0 with acetic acid.

2. Antibacterial Experiments of Fresh-Keeping Agents with Different Weight Percentages

The prepared fresh-keeping agents with different weight percentages were subjected to Botrytis cinerea antibacterial experiment, and the Galla chinensis extract was used as a control. The results were shown in the following table:

TABLE 2
Antibacterial effect of fresh-keeping agents
with different percentages

| | composition of the | inhibition zone |
|---|---|---|
| | fresh-keeping | diameter/ |
| No. | agent | mm |
| 1 | Galla chinensis extract 0.03% | 16.5 |
| | ascorbic acid 0 | |
| | chitosan 0 | |
| 2 | Galla chinensis extract 0.03% | 21.8 |
| | ascorbic acid 0.5% | |
| | Chitosan 1.0% | |
| 3 | Galla chinensis extract 0.03% | 23.5 |
| | ascorbic acid 1.0% | |
| | Chitosan 2.0% | |
| 4 | Galla chinensis extract 0.1% | 25.7 |
| | ascorbic acid 0.5% | |
| | Chitosan 1.0% | |
| 5 | Galla chinensis extract 0.1% | 27.2 |
| | ascorbic acid 0.8% | |
| | Chitosan 1.5% | |
| 6 | Galla chinensis extract 0.5% | 29.8 |
| | ascorbic acid 1.0% | |
| | Chitosan 2% | |
| 7 | Galla chinensis extract 0.8% | 30.4 |
| | ascorbic acid 1.2% | |
| | Chitosan 2.5% | |

It can be seen from the results that the combination of ascorbic acid, chitosan and the Galla chinensis extract significantly increased antibacterial activity of the Galla chinensis extract. Gallnut tannin had strong reducibility property, and the addition of ascorbic acid has a protected effect to the Gallnut tannin. Chitosan was a good film-forming agent, which may form a relatively dense protective film on a fruit surface, and block most of the air so as to inhibit respiratory metabolism of the fruit. The Galla chinensis extract was cooperated with the antioxidant and the film-forming agent, and produced significant antiseptic and antibacterial abilities against Botrytis cinerea, thereby achieving antisepsis and fresh-keeping effect of blueberries.

### Example 7 Method for Fresh-Keeping Blueberries with the Blueberry Fresh-Keeping Agent

A method for applying a blueberry fresh-keeping agent to blueberry fresh-keeping, which was carried out as follows.

1. Preparation of the Galla chinensis extract: removing internal eggs of high-quality dried Galla chinensis and then pulverizing using a high-speed powder machine, and ultrasonically extracting with 75% (V/V) ethanol, solid-liquid ratio of 1:15 (W/V) at room temperature (power 300 W) for 1 h, centrifuging for 10 min and collecting a supernatant, and rotationally evaporating the supernatant to dryness at 50° C., a crude extract is obtained; redissolving the crude extract with water, extracting with ethyl acetate and collecting an ethyl acetate layer, and evaporating the ethyl acetate layer to dryness, the Galla chinensis extract is obtained.

2. Preparation of a blueberry green fresh-keeping agent: the Galla chinensis extract 0.1%, ascorbic acid 0.5%, chitosan 1.0%, balanced with distilled water, which were solubilized with 0.5% of Tween80, stirred and mixed, pH value was adjusted to 6.0 with acetic acid.

3. Treatment method: fresh blueberries, which were relatively consistent in maturity (8˜9 mature), had uniform size, no mechanical damage, no pests and diseases, were selected, rinsed with water, drained, soaked in the fresh-keeping agent solution for 1 min, taken out and dried, then placed in a plastic box with air holes for storage. After the fresh blueberries were pre-cooled for 3 h in a cold storage at 4° C., they were stored at 4° C. for cooling. The mildew and decay condition of fruit was check every 10 days until the end of storage.

Further, taking a storage method without using the fresh-keeping agent as a control, and the treatment method was as follows.

Fresh blueberries, which were relatively consistent in maturity (8˜9 mature), had uniform size, no mechanical damage, no pests and diseases, were selected, rinsed with water, drained, then placed in a plastic box with air holes for storage. After the fresh blueberries were pre-cooled for 3 h in a cold storage at 4° C., they were stored at 4° C. for cooling. The mildew and decay condition of fruit was check every 10 days until the end of storage.

4. Blueberry fruits in the treated group and the control were tested according to the following methods. The sampling time was 0 d, 10 d, 20 d, 30 d, 40 d, 50 d, 60 d and 70 d, where:

(1) fruit decay rate measurement: fruit decay rate (%)=number of decayed fruits/total number of fruits×100%, the decayed fruit refers to that at least one place on the surface of the fruit was juice leaking, softening or decayed.

(2) weight loss rate: it was measured using a weighing method, using initial weight of a sample to minus weight weighed each time during storage to obtain a difference, a ratio of the difference to the initial weight of the sample was the weight loss rate, expressed in %.

(3) pulp membrane permeability measurement: the pulp membrane permeability was studied by measuring relative conductivity. 1 mm thick blueberry slices were cut, mixed and taken 20 slices out. The 20 slices were totally 3.0 g, and placed in a 25 mL tube, 25.0 mL of deionized water was added therein, after shaking for 30 min on a shaker, solution conductivity P₁ was measured using a conductivity meter. After the measurement of conductivity, the solution was boiled for 10 min, cooled to room temperature, water was added to an original scale, and solution conductivity P₂ was measured using the conductivity meter; deionized water conductivity P₀ was measured. The relative conductivity was calculated as follows, representing the pulp membrane permeability.

P=(P₁−P₀)/(P₂−P₀)×100%

(4) malondialdehyde content (MDA) measurement: the effect of the fresh-keeping agent on blueberry membrane lipid peroxidation was characterized by the change of MDA content. 1 g of a blueberry frozen sample was weighed and placed in a 10 mL centrifuge tube, 5 mL 100 g/L of a TCA solution was added therein to obtain a mixture, centrifuging the mixture at 10 000 r/min for 20 min at 4° C., and a supernatant was collected. 2.0 mL of the supernatant (2.0 mL 100 g/L TCA solution was added in a blank control) was taken, to which 2.0 mL 0.67% of a thiobarbituric acid solution was added, mixed and boiled in a boiling water bath for 20 min, and absorbance values at wavelengths of 450, 532 and 600 nm were measured, respectively.

(5) pulp phenylalanine ammonia-lyase (PAL) activity measurement: 3 mL of a reaction solution includes 1.5 mmol/L of ascorbic acid 1 mL, 0.1875 mmol/L of EDTA-Na 1.6 mL, 1 mmol/L of H₂O₂ 0.3 mL and an enzyme solution 0.1 mL. Starting with the addition of H₂O₂, the changes of light absorption value at 290 nm were recorded within 1 min. A change of 0.01 per minute indicates an enzymatic unit (U).

(6) pulp polyphenol oxidase (PPO) activity measurement: a reaction system included 0.1 mol of catechol 2.9 mL, a supernatant enzyme solution 0.1 mL, which were mixed, placed in a UV spectrophotometer within 15 s, and measured the changes of absorbance at 420 nm within 3 min, using a reaction solution without a substrate of catechol as a control. A change of 0.01 per minute indicates an enzymatic unit (U).

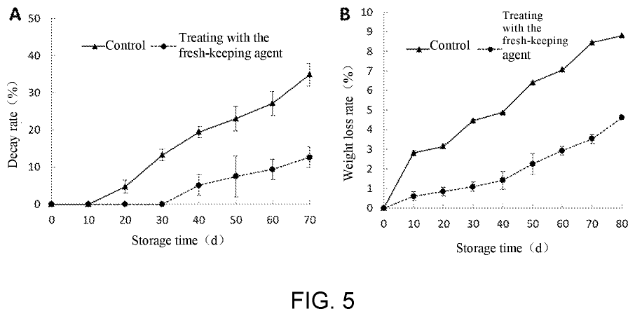

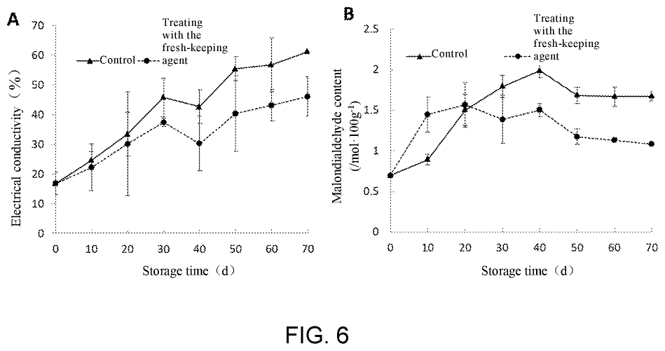

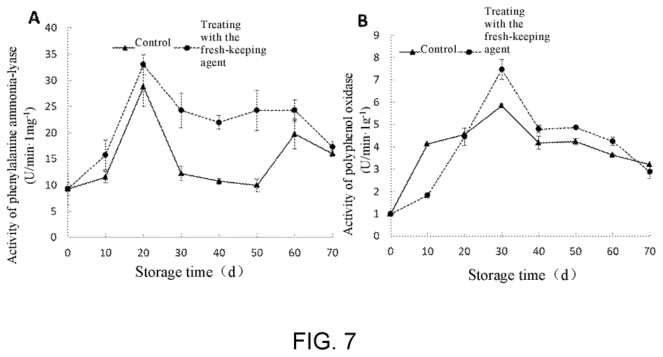

The results of the measurements were shown in FIGS. 3, 4 and 5. It can be seen that with the prolongation of storage time, the decay rate and weight loss rate of blueberry fruit gradually increased, and the quality gradually decreased. The method of the present disclosure may reduce the fruit decay rate and weight loss rate well, when storage for 30 days, the fruit decay rate in general storage methods reached to 13.26%, while the fruit in the present method had not decayed, and when storage time was prolonged to 50 days, the fruit decay rate in general storage methods reached to 23.00%, while the decay rate using the present disclosure may reduce within 10%. At the same time, the present method may well inhibit the water loss during blueberry storage, resulting in the weight loss rate of blueberries was controlled within 5%. The fresh-keeping agent and fresh-keeping method of the present disclosure may effectively alleviate post-harvest blueberry membrane lipid peroxidation and maintain blueberry cell membrane completeness. In addition, the present disclosure may also significantly (P<0.05) improve the activity of phenylalanine ammonia-lyase and polyphenol oxidase related to self-resistance to disease of post-harvest blueberry, and effectively improve blueberry disease resistance and prolong storage time. In summary, applying the fresh-keeping agent according to the present disclosure may significantly inhibit decay and water loss of post-harvest blueberries, alleviate membrane lipid peroxidation, improve blueberry disease resistance, and maintain storage quality of blueberries.

### Example 8 Method for Fresh-Keeping Blueberries with the Blueberry Fresh-Keeping Agent

A method for applying the blueberry fresh-keeping agent for blueberry fresh-keeping, which was carried out as follows.

1. Preparation of the Galla chinensis extract: removing internal eggs of high-quality dried Galla chinensis and then pulverizing using a high-speed powder machine, and ultrasonically extracting with 75% (V/V) ethanol, solid-liquid ratio of 1:20 (W/V) at room temperature (power 300 W) for 2 h, centrifuging for 10 min and collecting a supernatant, and rotationally evaporating the supernatant to dryness at 45° C., a crude extract is obtained; redissolving the crude extract with water, extracting with ethyl acetate and collecting an ethyl acetate layer, and evaporating the ethyl acetate layer to dryness, the Galla chinensis extract is obtained.

2. Preparation of the blueberry green fresh-keeping agent: the Galla chinensis extract 0.03%, ascorbic acid 1.0%, chitosan 2.0%, balanced with distilled water, which were solubilized with 1.0% Tween80, stirred and mixed, pH value was adjusted to 2.0 with acetic acid.

3. Treatment method: fresh blueberries, which were relatively consistent in maturity (8˜9 mature), had uniform size, no mechanical damage, no pests and diseases, were selected, rinsed with water, drained, soaked in the fresh-keeping agent solution for 2 min, taken out and dried, then placed in a plastic box with air holes for storage. After the fresh blueberries were pre-cooled for 2 h in a cold storage at 1° C., they were stored at 1° C. for cooling. The mildew and decay condition of fruit was check every 10 days until the end of storage.

The technical effects tested through experimental in this example are the same to that achieved in the Example 7, and will not be repeated here.

### Example 9 Method for Fresh-Keeping Blueberries with the Blueberry Fresh-Keeping Agent

A method for applying the blueberry fresh-keeping agent for blueberry fresh-keeping, which was carried out as follows.

1. Preparation of a Galla chinensis extract: removing internal eggs of high-quality dried Galla chinensis and then pulverizing using a high-speed powder machine, and ultrasonically extracting with 75% (V/V) ethanol, solid-liquid ratio of 1:10 (W/V) at room temperature (power 300 W) for 0.5 h, centrifuging for 10 min and collecting a supernatant, and rotationally evaporating the supernatant to dryness at 60° C., a crude extract is obtained; redissolving the crude extract with water, extracting with ethyl acetate and collecting an ethyl acetate layer, and evaporating the ethyl acetate layer to dryness, the Galla chinensis extract is obtained.

2. Preparation of the blueberry green fresh-keeping agent: the Galla chinensis extract 0.5%, ascorbic acid 1.0%, chitosan 2.0%, balanced with distilled water, which were solubilized with 2.0% Tween80, stirred and mixed, pH was adjusted to 4.0 with acetic acid.

3. Treatment method: fresh blueberries, which were relatively consistent in maturity (8˜9 mature), had uniform size, no mechanical damage, no pests and diseases, were selected, rinsed with water, drained, soaked in a fresh-keeping agent solution for 1.5 min, taken out and dried, then placed in a plastic box with air holes for storage. After the fresh blueberries were pre-cooled for 4 h in a cold storage at 5° C., they were stored at 5° C. for cooling. The mildew and decay condition of fruit was check every 10 days until the end of storage.

The technical effects tested through experimental in this example are the same to that achieved in the Example 7, and will not be repeated here.

### Example 10 Method for Fresh-Keeping Grapes and Black Plums with the Blueberry Fresh-Keeping Agent

A method for applying the blueberry fresh-keeping agent for fresh-keeping of grapes and black plums, which was carried out as follows.

1. Preparation of a Galla chinensis extract: removing internal eggs of high-quality dried Galla chinensis and then pulverizing using a high-speed powder machine, and ultrasonically extracting with 75% (V/V) ethanol, solid-liquid ratio of 1:10 (W/V) at room temperature (power 300 W) for 0.5 h, centrifuging for 10 min and collecting a supernatant, and rotationally evaporating the supernatant to dryness at 60° C., a crude extract is obtained; redissolving the crude extract with water, extracting with ethyl acetate and collecting an ethyl acetate layer, and evaporating the ethyl acetate layer to dryness, the Galla chinensis extract is obtained.

2. Preparation of a blueberry green fresh-keeping agent: the Galla chinensis extract 0.5%, ascorbic acid 1.0%, chitosan 2.0%, balanced with distilled water, which were solubilized with 2.0% Tween80, stirred and mixed, pH value was adjusted to 4.0 with acetic acid.

3. Treatment method: fresh grapes and black plums, which were relatively consistent in maturity (8˜9 mature), had uniform size, no mechanical damage, no pests and diseases, were selected, rinsed with water, drained, soaked in a fresh-keeping agent solution for 1.5 min, taken out and dried, then placed in a plastic box with air holes for storage. After the fresh blueberries were pre-cooled for 3 h in a cold storage at 4° C., they were stored at 4° C. for cooling. The mildew and decay condition of fruit was check every 10 days until the end of storage. Taking a storage method without using the fresh-keeping agent as a control.

With the prolongation of storage time, the decay rate and weight loss rate of grapes and black plums gradually increased, and the quality gradually decreased. When storage for 30 days, the decay rate of grape fruit reached to 20.36%, the decay rate of black plum fruit reached to 10.57% in the treatment group, and pulp thereof became softening. The water loss of the two fruits was obvious, and electrical conductivity was not significantly lower than that of the control groups, that is, the membrane lipid peroxidation of grapes and black plums was not effectively alleviated. The above results indicated that the fresh-keeping agent has no obvious fresh-keeping effect to grapes and black plums, and specific reasons need further analysis.

In combination with the above examples, the fresh-keeping agent according to the present disclosure may significantly inhibit decay and water loss of the post-harvest blueberries, alleviate blueberry membrane lipid peroxidation, and significantly improve the activity of phenylalanine ammonia-lyase and polyphenol oxidase related to self-resistance to disease of post-harvest blueberry, so as to enhance blueberry disease resistance, and effectively maintain storage quality of the blueberries.

What is claimed is:

1. A blueberry fresh-keeping agent, wherein the blueberry fresh-keeping agent is consisted of 0.03%-0.5% of a Galla chinensis extract, 0.5%-1.0% of ascorbic acid and 1.0%-2.0% of chitosan.

2. The blueberry fresh-keeping agent according to claim 1, wherein the blueberry fresh-keeping agent has a pH of 2.0-6.0.

3. The blueberry fresh-keeping agent according to claim 1, wherein when preparation of the fresh-keeping agent, a ratio of solid to liquid during ethanol extraction of Galla chinensis is 1:10-1:20 (W/V), and an ultrasonic treatment time is 0.5-2 hours, a vacuum rotational evaporation temperature is no more than 60° C.

4. The blueberry fresh-keeping agent according to claim 1, wherein when preparation of the fresh-keeping agent, Tween 80 of 0.5% to 2% is added for solubilization during the dissolving.

5. A method for preparing the blueberry fresh-keeping agent of claim 1, wherein the method is carried out according to the following steps:
(1) preparing the Galla chinensis extract: removing internal eggs of high-quality dried Galla chinensis, then pulverizing using a high-speed powder machine, and ultrasonically extracting with 75% ethanol at room temperature, centrifuging and collecting a supernatant, and rotationally evaporating the supernatant to dryness, a crude extract is obtained; redissolving the crude extract with water, extracting with ethyl acetate and collecting an ethyl acetate layer, evaporating the ethyl acetate layer to dryness, the Galla chinensis extract is obtained;
(2) separately adding the Galla chinensis extract, the ascorbic acid and the chitosan by weight percentage to distilled water for dissolving;
(3) after a mixed solution is thoroughly stirred and mixed, pH is adjusted to 2.0-6.0, the blueberry fresh-keeping agent is obtained.

6. A method for treating blueberries with the blueberry fresh-keeping agent according to claim 1, comprising the following steps:
(1) rinsing blueberries freshly picked with water, draining for use;
(2) soaking the rinsed blueberries in the blueberry fresh-keeping agent, taking out, drying and placing in a plastic box with air holes;
(3) pre-cooling the blueberries treated with the blueberry fresh-keeping agent in a pre-cooling storage and storing at a low temperature.

7. The method according to claim 6, wherein a time for soaking with the blueberry fresh-keeping agent is 1-2 min, a temperature of the pre-cooling storage is 1° C.-5° C., a pre-cooling time is 2-4 hours, and the temperature of the storing is 1° C.-5° C.
